(19) United States
(12) Patent Application Publication
(10) Pub. No.: US 2004/0230963 A1
(43) Pub. Date: Nov. 18, 2004

(54) Method for updating firmware in an operating system agnostic manner

(76) Inventors: Michael A. Rothman, Gig Harbor, WA (US); Vincent J. Zimmer, Federal Way, WA (US)

Correspondence Address: R. Alan Burnett, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/438,136

(22) Filed: May 12, 2003

(51) Int. Cl. G06F 9/44

(52) U.S. Cl. 717/168

(57) ABSTRACT

Firmware-based method and architecture scheme for updating firmware in an operating system agnostic manner. A generic (i.e., non component-specific) application program interface (API) is published during a pre-boot phase and remains available during operating system runtime. The API is independent of operating systems that may run on a computer system containing the firmware that is updated. A runtime update application interfaces with the generic API to store update variable data corresponding to the update. During a subsequent pre-boot phase, the update variable data are read to identify a component-specific API or a firmware component that does not publish an API to use for the update and to locate a firmware image and/or explicitly define configuration data corresponding to the update. The firmware update is then effectuated by writing the firmware image and/or configuration data to a firmware device corresponding to the component for which firmware is updated via the component-specific API or firmware component.

### FIELD OF THE INVENTION

The field of invention relates generally to computer systems and, more specifically but not exclusively relates to an operating system agnostic scheme for updating firmware.

### BACKGROUND INFORMATION

Computer platform firmware is used during initialization of computer systems to verify system integrity and configuration. It also generally provides the basic low-level interface between hardware and software components of those computer systems, enabling specific hardware functions to be implemented via execution of higher-level software instructions contained in computer programs that run on the computer systems. In many computers, a primary portion of this firmware is known as the Basic Input/Output System (BIOS) code of a computer system. The BIOS code comprises a set of permanently recorded (or semi-permanently recorded in the case of systems that use flash BIOS) software routines that provides the system with its fundamental operational characteristics, including instructions telling the computer how to test itself when it is turned on, and how to determine the configurations for various built-in components and add-in peripherals.

In a typical PC architecture, the BIOS is generally defined as the firmware that runs between the processor reset and the first instruction of the Operating System (OS) loader. This corresponds to the startup operations performed during a cold boot or in response to a system reset. At the start of a cold boot, very little of the system beyond the processor and firmware is actually initialized. It is up to the code in the firmware to initialize the system to the point that an operating system loaded off of media, such as a hard disk, can take over.

Typically, firmware code is stored in a “monolithic” form comprising a single set of code that is provided by a platform manufacturer or a BIOS vendor such as Phoenix or AMI. Various portions of the single set of code are used to initialize different system components, while other portions are used for run-time (i.e., post-boot) operations. In other situations, a monolithic BIOS may be extended using one or more “Option ROMs” that are contained on one or more periphery device cards (a.k.a., “add-in” cards). For example, SCSI device driver cards and video cards often include an option ROM that contains BIOS code corresponding to services provided by these cards. Typically, firmware in option ROMs is loaded after the firmware in the monolithic BIOS has been loaded or during loading of the monolithic BIOS in accordance with a predefined scheme.

Firmware can be updated in one of two manners. If the firmware is stored on a read-only (i.e., non-writable) device, such as a conventional ROM, the only way to update the firmware is to replace the firmware storage device. This technique is a highly disfavored for most end users, as well as vendors, since it requires someone to replace one or more ROM chips on a motherboard or option ROM chips on an add-in card. System firmware may also be updated during operating system “runtime” operations, that is, while the computer is running subsequent to an OS boot. Traditionally, runtime firmware updating has required direct hardware access and special OS-specific device/component/platform support. This typically requires that the OEM (original equipment manufacturer) or IHV (independent hardware vendor) write an update driver for every operating system target for use by the corresponding system device, component, or platform. Furthermore, the update driver usually must be included as part of the set of drivers that may be used under a given operation system, creating a headache for both the OEM/IHV and the OS vendor.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a schematic diagram illustrating the various execution phases that are performed in accordance with the extensible firmware interface (EFI) framework;

FIG. 2 is a block schematic diagram illustrating various components of the EFI system table that employed by embodiments of the invention during a firmware update process;

FIG. 3 is a schematic diagram illustrating an firmware update technique in accordance with one embodiment of the invention;

FIG. 4 is a flowchart illustrating logic and operations performed during operating system runtime as part of a two-phase update process in accordance with one embodiment of the invention;

FIG. 5A is a flowchart illustrating logic and operations performed during pre-boot operations following the runtime operation of FIG. 4 in accordance one embodiment of the two-phase update process;

FIG. 5B is a flowchart illustrating logic and operations performed during pre-boot operations following the runtime operation of FIG. 4 in accordance another embodiment of the two-phase update process; and

FIG. 6 is a schematic diagram illustrating an exemplary computer server that may be employed for implementing the embodiments of the invention disclosed herein.

### DETAILED DESCRIPTION OF PREFERRED EMBODIMENTS

Embodiments of methods, components, and computer systems corresponding to a scheme for updating firmware in an operating system agnostic manner are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In accordance with aspects of the invention, a framework is disclosed that provides a standardized mechanism to enable system and add-in card firmware to be updated in an OS agnostic manner. The framework supports a PULL model that enables firmware component to effect an update, while a framework API (application program interface) is used to engender the update. It also enables firmware updates in the OS space without the need for OS-specific driver that have traditionally been needed for direct hardware access. This capability is termed “OS agnostic,” meaning the framework is operating system independent, and that framework components need not be aware of what operating system is running. Furthermore, the framework API provides an abstracted interface that supports firmware updates without requiring intimate knowledge of the firmware being updated.

In accordance with one embodiment, the firmware update framework may be implemented under an extensible firmware framework known as the Extensible Firmware Interface (EFI) (specifications and examples of which may be found at http://developer.intel.com/technology/efi). EFI is a public industry specification that describes an abstract programmatic interface between platform firmware and shrink-wrap operation systems or other custom application environments. The EFI framework include provisions for extending BIOS functionality beyond that provided by the BIOS code stored in a platform's BIOS device (e.g., flash memory). More particularly, EFI enables firmware, in the form of firmware modules and drivers, to be loaded from a variety of different resources, including primary and secondary flash devices, option ROMs, various persistent storage devices (e.g., hard disks, CD ROMs, etc.), and even over computer networks.

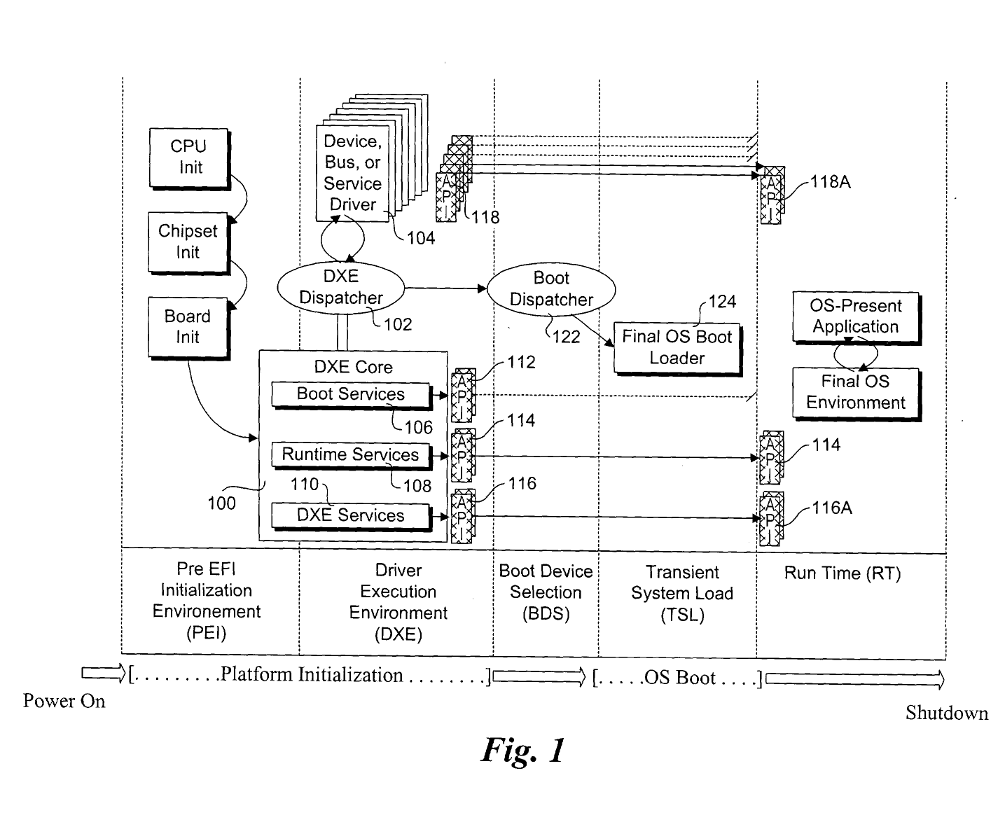

FIG. 1 shows an event sequence/architecture diagram used to illustrate operations performed by a platform under the framework in response to a cold boot (e.g., a power off/on reset). The process is logically divided into several phases, including a pre-EFI Initialization Environment (PEI) phase, a Driver Execution Environment (DXE) phase, a Boot Device Selection (BDS) phase, a Transient System Load (TSL) phase, and an operating system runtime (RT) phase. The phases build upon one another to provide an appropriate run-time environment for the OS and platform.

The PEI phase provides a standardized method of loading and invoking specific initial configuration routines for the processor (CPU), chipset, and motherboard. The PEI phase is responsible for initializing enough of the system to provide a stable base for the follow on phases. Initialization of the platforms core components, including the CPU, chipset and main board (i.e., motherboard) is performed during the PEI phase. This phase is also referred to as the “early initialization” phase. Typical operations performed during this phase include the POST (power-on self test) operations, and discovery of platform resources. In particular, the PEI phase discovers memory and prepares a resource map that is handed off to the DXE phase. The state of the system at the end of the PEI phase is passed to the DXE phase through a list of position independent data structures called Hand Off Blocks (HOBs).

The DXE phase is the phase during which most of the system initialization is performed. The DXE phase is facilitated by several components, including the DXE core 100, the DXE dispatcher 102, and a set of DXE drivers 104. The DXE core 100 produces a set of Boot Services 106, Runtime Services 108, and DXE Services 110. The DXE dispatcher 102 is responsible for discovering and executing DXE drivers 104 in the correct order. The DXE drivers 104 are responsible for initializing the processor, chipset, and platform components as well as providing software abstractions for console and boot devices. These components work together to initialize the platform and provide the services required to boot an operating system. The DXE and the Boot Device Selection phases work together to establish consoles and attempt the booting of operating systems. The DXE phase is terminated when an operating system successfully begins its boot process (i.e., the BDS phase starts). Only the runtime services and selected DXE services provided by the DXE core and selected services provided by runtime DXE drivers are allowed to persist into the OS runtime environment. The result of DXE is the presentation of a fully formed EFI interface.

The DXE core is designed to be completely portable with no CPU, chipset, or platform dependencies. This is accomplished by designing in several features. First, the DXE core only depends upon the HOB list for its initial state. This means that the DXE core does not depend on any services from a previous phase, so all the prior phases can be unloaded once the HOB list is passed to the DXE core. Second, the DXE core does not contain any hard coded addresses. This means that the DXE core can be loaded anywhere in physical memory, and it can function correctly no matter where physical memory or where Firmware segments are located in the processor's physical address space. Third, the DXE core does not contain any CPU-specific, chipset specific, or platform specific information. Instead, the DXE core is abstracted from the system hardware through a set of architectural protocol interfaces. These architectural protocol interfaces are produced by DXE drivers 104, which are invoked by DXE Dispatcher 102.

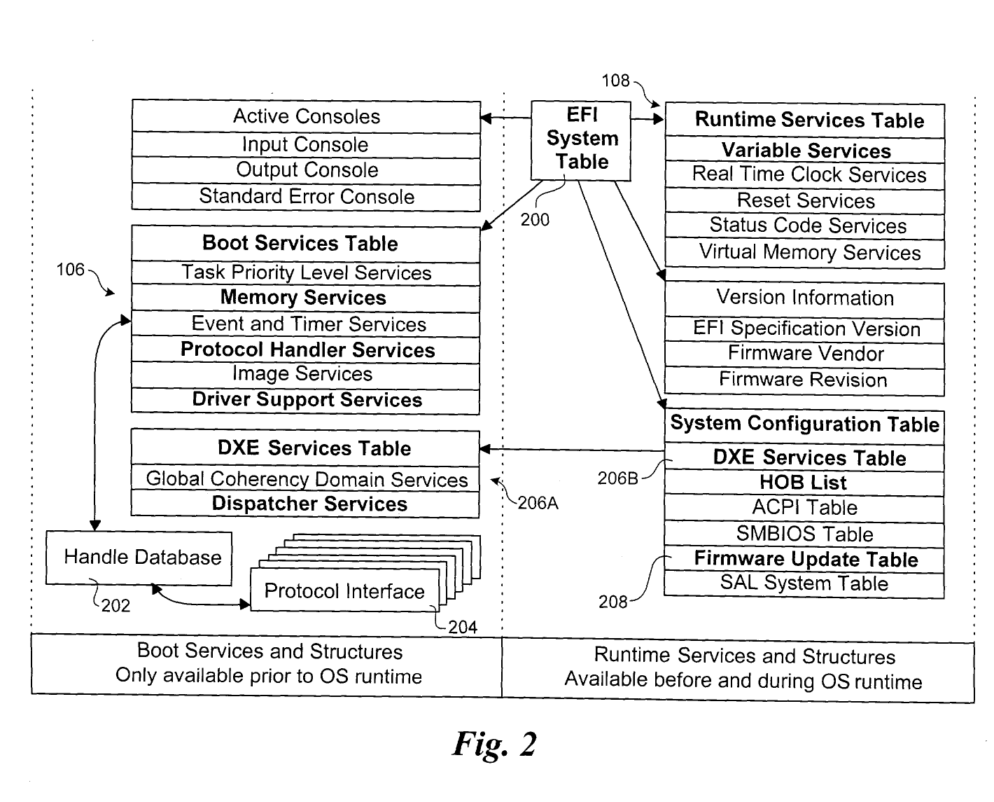

The DXE core produces an EFI System Table 200 and its associated set of Boot Services 106 and Runtime Services 108, as shown in FIG. 2. The DXE Core also maintains a handle database 202. The handle database comprises a list of one or more handles, wherein a handle is a list of one or more unique protocol GUIDs (Globally Unique Identifiers) that map to respective protocols 204. A protocol is a software abstraction for a set of services. Some protocols abstract I/O devices, and other protocols abstract a common set of system services. A protocol typically contains a set of APIs and some number of data fields. Every protocol is named by a GUID, and the DXE Core produces services that allow protocols to be registered in the handle database. As the DXE Dispatcher executes DXE drivers, additional protocols will be added to the handle database including the architectural protocols used to abstract the DXE Core from platform specific details.

The Boot Services comprise a set of services that are used during the DXE and BDS phases. Among others, these services include Memory Services, Protocol Handler Services, and Driver Support Services: Memory Services provide services to allocate and free memory pages and allocate and free the memory pool on byte boundaries. It also provides a service to retrieve a map of all the current physical memory usage in the platform. Protocol Handler Services provides services to add and remove handles from the handle database. It also provides services to add and remove protocols from the handles in the handle database. Addition services are available that allow any component to lookup handles in the handle database, and open and close protocols in the handle database. Support Services provides services to connect and disconnect drivers to devices in the platform. These services are used by the BDS phase to either connect all drivers to all devices, or to connect only the minimum number of drivers to devices required to establish the consoles and boot an operating system (i.e., for supporting a fast boot mechanism).

In contrast to Boot Services, Runtime Services are available both during pre-boot and OS runtime operations. One of the Runtime Services that is leveraged by embodiments disclosed herein is the Variable Services. As described in further detail below, the Variable Services provide services to lookup, add, and remove environmental variables from both volatile and non-volatile storage. As used herein, the Variable Services is termed “generic” since it is independent of any system component for which firmware is updated by embodiments of the invention.

The DXE Services Table includes data corresponding to a first set of DXE services 206A that are available during pre-boot only, and a second set of DXE services 206B that are available during both pre-boot and OS runtime. The pre-boot only services include Global Coherency Domain Services, which provide services to manage I/O resources, memory mapped I/O resources, and system memory resources in the platform. Also included are DXE Dispatcher Services, which provide services to manage DXE drivers that are being dispatched by the DXE dispatcher.

The services offered by each of Boot Services 106, Runtime Services 108, and DXE services 110 are accessed via respective sets of API's 112, 114, and 116. The API's provide an abstracted interface that enables subsequently loaded components to leverage selected services provided by the DXE Core.

After DXE Core 100 is initialized, control is handed to DXE Dispatcher 102. The DXE Dispatcher is responsible for loading and invoking DXE drivers found in firmware volumes, which correspond to the logical storage units from which firmware is loaded under the EFI framework. The DXE dispatcher searches for drivers in the firmware volumes described by the HOB List. As execution continues, other firmware volumes might be located. When they are, the dispatcher searches them for drivers as well.

There are two subclasses of DXE drivers. The first subclass includes DXE drivers that execute very early in the DXE phase. The execution order of these DXE drivers depends on the presence and contents of an a priori file and the evaluation of dependency expressions. These early DXE drivers will typically contain processor, chipset, and platform initialization code. These early drivers will also typically produce the architectural protocols that are required for the DXE core to produce its full complement of Boot Services and Runtime Services.

The second class of DXE drivers are those that comply with the EFI 1.10 Driver Model. These drivers do not perform any hardware initialization when they are executed by the DXE dispatcher. Instead, they register a Driver Binding Protocol interface in the handle database. The set of Driver Binding Protocols are used by the BDS phase to connect the drivers to the devices required to establish consoles and provide access to boot devices. The DXE Drivers that comply with the EFI 1.10 Driver Model ultimately provide software abstractions for console devices and boot devices when they are explicitly asked to do so.

Any DXE driver may consume the Boot Services and Runtime Services to perform their functions. However, the early DXE drivers need to be aware that not all of these services may be available when they execute because all of the architectural protocols might not have been registered yet. DXE drivers must use dependency expressions to guarantee that the services and protocol interfaces they require are available before they are executed.

The DXE drivers that comply with the EFI 1.10 Driver Model do not need to be concerned with this possibility. These drivers simply register the Driver Binding Protocol in the handle database when they are executed. This operation can be performed without the use of any architectural protocols. In connection with registration of the Driver Binding Protocols, a DXE driver may “publish” an API by using the InstallConfiguration Table function. This published drivers are depicted by API's 118. Under EFI, publication of an API exposes the API for access by other firmware components. The API's provide interfaces for the Device, Bus, or Service to which the DXE driver corresponds during their respective lifetimes.

The BDS architectural protocol executes during the BDS phase. The BDS architectural protocol locates and loads various applications that execute in the pre-boot services environment. Such applications might represent a traditional OS boot loader, or extended services that might run instead of, or prior to loading the final OS. Such extended pre-boot services might include setup configuration, extended diagnostics, flash update support, OEM value-adds, or the OS boot code. A Boot Dispatcher 120 is used during the BDS phase to enable selection of a Boot target, e.g., an OS to be booted by the system.

During the TSL phase, a final OS Boot loader 122 is run to load the selected OS. Once the OS has been loaded, there is no further need for the Boot Services 106, and for many of the services provided in connection with DXE drivers 104 via API's 118, as well as DXE Services 206A. Accordingly, these reduced sets of API's that may be accessed during OS runtime are depicted as API's 116A, and 118A in FIG. 1.

In accordance with aspects of the invention, the pre-boot/boot framework of FIG. 1 may be implemented to enable update of various firmware, including system firmware (i.e., firmware stored on a motherboard firmware device or the like) and add-in firmware (e.g., firmware commonly associated with option ROMs). This is facilitated, in part, by API's published by respective components/devices during the DXE phase, and through use of the Variable Services runtime service.

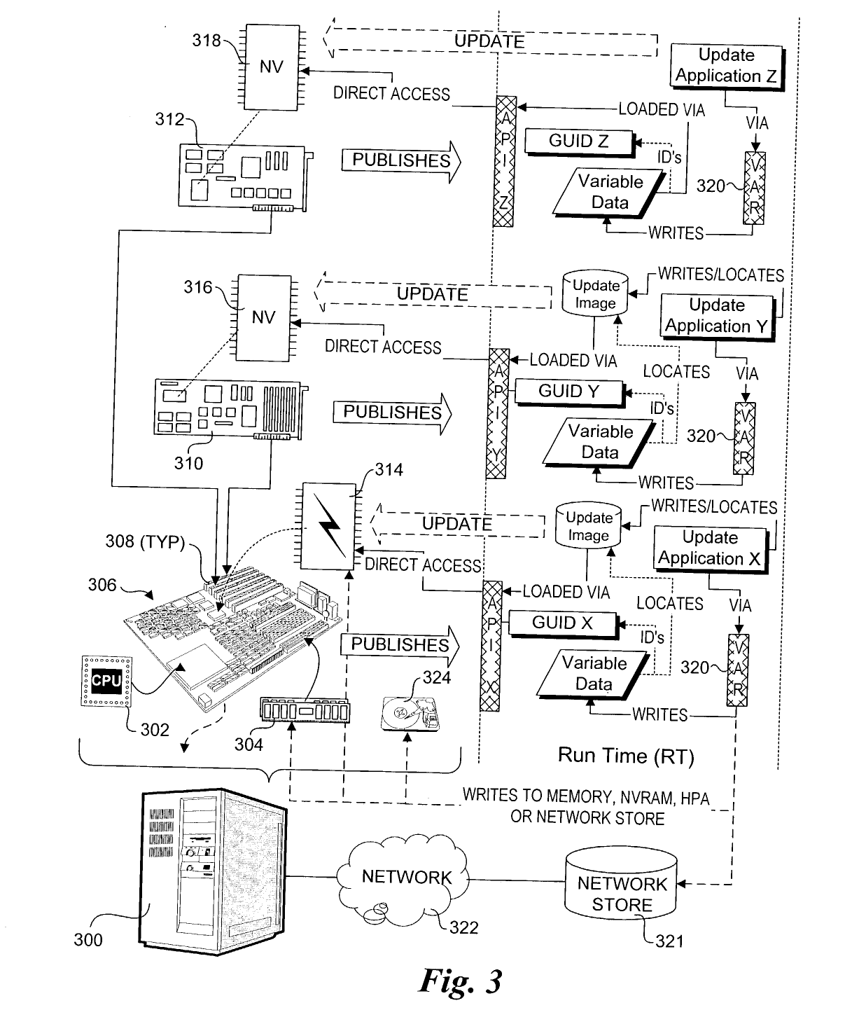

For example, an implementation of a firmware update scheme that is performed in accordance with an exemplary computer server system configuration is shown in FIG. 3. The system comprises a computer server 300, which includes one or more processors 302 and one or more memory modules 304 coupled to a motherboard 306. The motherboard provides a plurality of expansion slots 308 in which add-in boards 310 and 312 are inserted. The motherboard further includes a firmware device 314 on which firmware code is stored. Under EFI, firmware device 314 comprises the boot firmware device (BFD) for server 300.

In modern computer systems, BFDs will typically comprise a rewritable non-volatile memory component, such as, but not limited to, a flash device or EEPROM chip. As used herein, these devices are termed “non-volatile (NV) rewritable memory devices.” In general, NV rewritable memory devices pertain to any device that can store data in a non-volatile manner (i.e., maintain data when the computer system is not operating), and provides both read and write access to the data. Thus, all or a portion of firmware stored on an NV rewritable memory device may be updated by rewriting data to appropriate memory ranges defined for the device.

In response to a system reset or power on event, the system performs pre-boot system initialization operations in the manner discussed above with reference to FIG. 1. Upon being reset, the processor executes reset stub code that jumps execution to the base address of the BFD (e.g., firmware device 314) via a reset vector. The BFD contains firmware instructions that are logically divided into a boot block and an EFI core.

The boot block contains firmware instructions for performing early initialization, and is executed by processor 302 to initialize the CPU, chipset, and motherboard. (It is noted that during a warm boot early initialization is not performed, or is at least performed in a limited manner). Execution of firmware instructions corresponding to the EFI core are executed next, leading to the DXE phase. After the DXE core is initialized, DXE dispatcher 102 begins loading DXE drivers 104. Each DXE driver corresponds to a system component, and provides an interface for directly accessing that component. Included in the DXE drivers is a driver that will be subsequently employed for updating firmware stored in a firmware device corresponding to the add-in component or platform for which the DXE driver is written. In the illustrated embodiment this device is depicted as firmware device 314, the BFD for the system. Loading of this driver causes a corresponding update API (“API X”) to be published by the EFI framework.

During further DXE phase operations, it is also discovered that each of add-in boards 310 and 312 include firmware instructions for accessing operations provided by the boards via respective option ROMs. In the illustrated embodiment the respective option ROMs comprise NV rewritable memory devices 316 and 318. The firmware stored in the NV rewritable memory devices may also be updated. Accordingly, when firmware instructions stored in NV rewritable memory devices 316 and 318 are loaded and executed by processor 302, respective update API's (“API Y” and “API Z”) are published. In one embodiment, each of update API's X, Y, and Z remain available for OS runtime access after completion of the DXE, BDS, and TSL phases.

In accordance with one embodiment, the firmware update process begins during OS runtime via an update application. Typically, the update application will comprise an OS-compatible application that is used to update firmware corresponding to one or more firmware devices. A respective update application may be employed for updating firmware corresponding to an individual system component, such as depicted by update applications X, Y, and Z in FIG. 3, or a single update application may be used to update firmware corresponding to two or more system components.

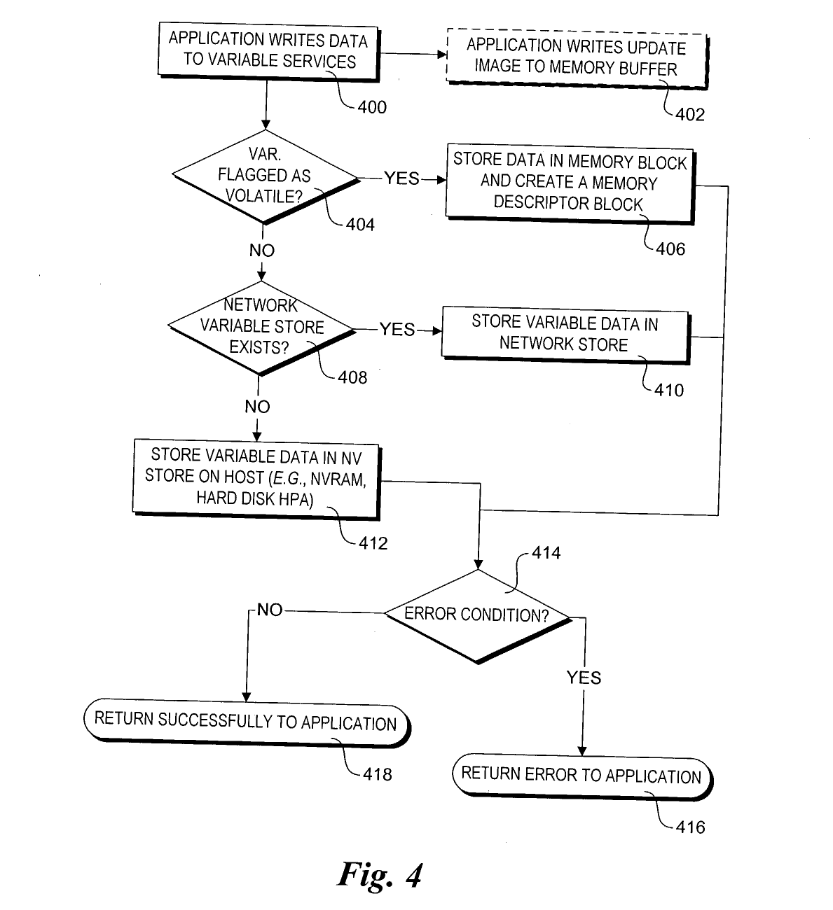

With reference to FIG. 4, a two-phase update process in accordance with one embodiment of the invention begins by using an update application to perform the following operations. First, in a block 400, the update application writes data to the Variable Services component of the Runtime Services 108 via a corresponding API, which is depicted as variable services API 320 in FIG. 3. The variables data are used to perform several functions, including apprising the system that an update is requested, identifying which update API is to be employed to facilitate the update, and providing other variable data that is employed to effect the update.

Under the Variable Services, variables are defined as key/value pairs that consist of identifying information plus attributes (the key) and arbitrary data (the value). Variables are intended for use as a means to store data that is passed between the EFI environment implemented in the platform and EFI OS loaders and other applications that run in the EFI environment. Although the implementation of variable storage is not defined in the EFI specification, variables must be persistent in most cases. This implies that the EFI implementation on a platform must arrange it so that variables passed in for storage are retained and available for use each time the system boots, at least until they are explicitly deleted or overwritten.

There are three variable service functions: GetVariable, GetNextVariableName, and SetVariable. GetVariable returns the value of a variable. GetNextVariableName enumerates the current variable names. SetVariable sets the value of a variable. Each of the GetVariable and SetVariable functions employ five parameters: VariableName, VendorGuid (a unique identifier for the vendor), Attributes (via an attribute mask), DataSize, and Data. The Data parameter identifies a buffer (via a memory address) to write or read the data contents of the variable from. The VariableName, VendorGuid parameters enable variables corresponding to a particular system component (e.g., add-in card) to be easily identified, and enables multiple variables to be attached to the same component.

In some instances, an update may be fully effectuated via changes to configuration data for a corresponding component (e.g., a peripheral device associated with an add-in card), which are stored in an NV rewritable memory device. This is depicted by the process flow illustrated for API Z in FIG. 3. In other instances, the update is effectuated by copying data from an update image to the NV rewritable memory device, typically but not limited to overwriting all or a portion of the memory space for the device corresponding to a current firmware image. Accordingly, in these instances the application will further write an update image to a memory buffer, as depicted by a block 402, as well as the process flows in FIG. 3 corresponding to API's X and Y.

In a decision block 404, a determination is made to whether the variable is flagged as volatile (via the attribute mask). If the answer is YES, the logic proceeds to a block 406 in which the variable data are stored in a memory block and a corresponding memory block descriptor is created. In one embodiment, the variable data are stored in system memory in connection with the EFI System Configuration Table. More particular, memory space corresponding to the EFI System Configuration Table can be allocated for variable data storage via the InstallConfiguration Table function. For clarity, this allocated memory is identified as “Firmware Update Table” 208 in FIG. 2. The corresponding memory block descriptor comprises a GUID entry in the System Configuration Table identifying the block containing the variable data.

If the answer to decision block 404 is NO, the logic proceeds to a decision block 408, wherein a determination is made to whether a network variable store exists. Under EFI, firmware devices may comprise substantially any storage device that may be accessed by the computer system. Such devices include storage devices (e.g., disk drives) that may be accessed via a computer network, such as depicted by network store 321 and network 322 in FIG. 3. In accordance with this scheme, firmware variable data may be stored on a targeted network-accessible storage device, i.e., the network variable store. If a network store is available, the answer to decision block 408 is YES, leading to storing the variable data in the network store in a block 410.

If there is no network variable store available and the variable is flagged as non-volatile, the variable needs to be stored in a non-volatile manner on the computer system itself, in accordance with a block 412. In addition to the boot block and the EFI core, the BFD may also contain a memory space that is allocated for storing variable data. This memory space is known as NVRAM. Thus, in one embodiment the variable data is written to the NVRAM portion of the BFD.

In another embodiment, the variable data are stored on a media storage device coupled to motherboard 306 via appropriate cables and interface card (e.g., SCSI card) (not shown), such as a hard disk 324. In accordance with the ATAPI 5 standard, a portion of the hard disk media may be allocated in a matter in which it is hidden from the operating system, yet accessible by the system firmware. This area, known as the host-protected area (HPA), may be used to store the variable data in a non-volatile manner. Since the area is hidden from the operating system, it is not accessed by the operating system, and thus doesn't need to have an operating system loaded to be accessed. Therefore, this portion of the media may also be accessed during pre-boot. As another result of not being accessible to the operating system, an appropriately configured DXE runtime driver will need to be employed to facilitate access to the hard disk during OS runtime.

In one embodiment of the update application runtime process, an error detection scheme is employed to ensure that the variable data were successfully written to their target storage device, as depicted by a decision block 414. If an error condition is detected, the logic flows to a return block 416 in which an error is returned to the application (typically via an error code). If the variable data store process is a success, the process returns to the application in accordance with a return block 418.

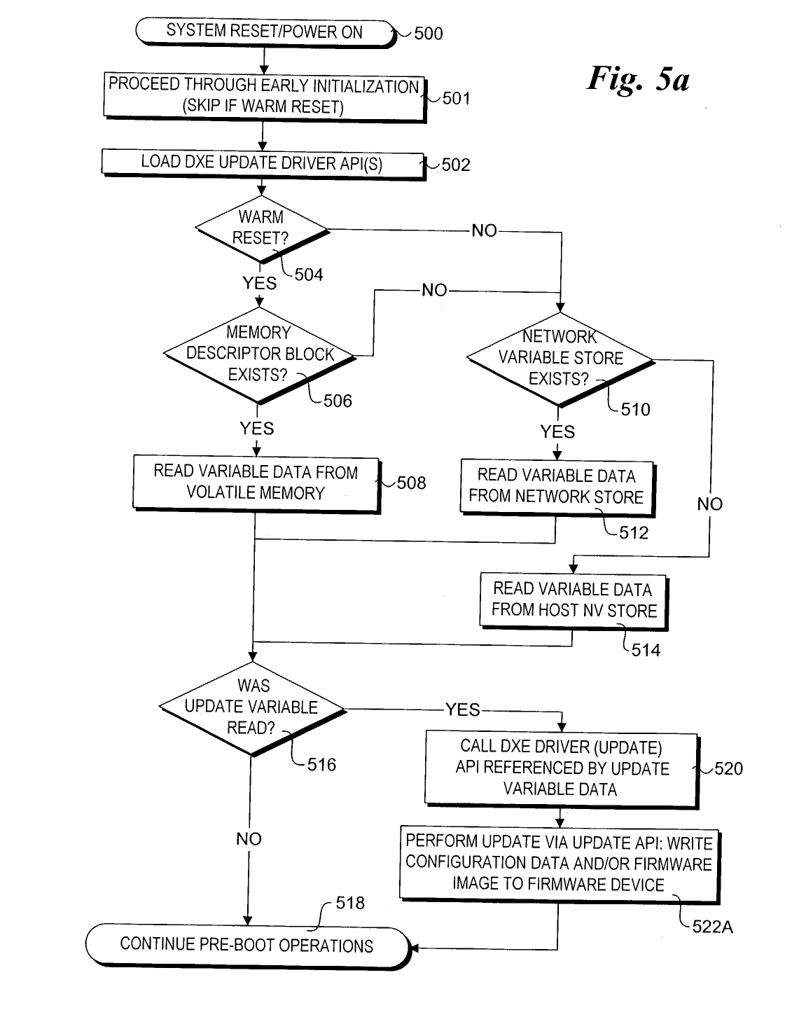

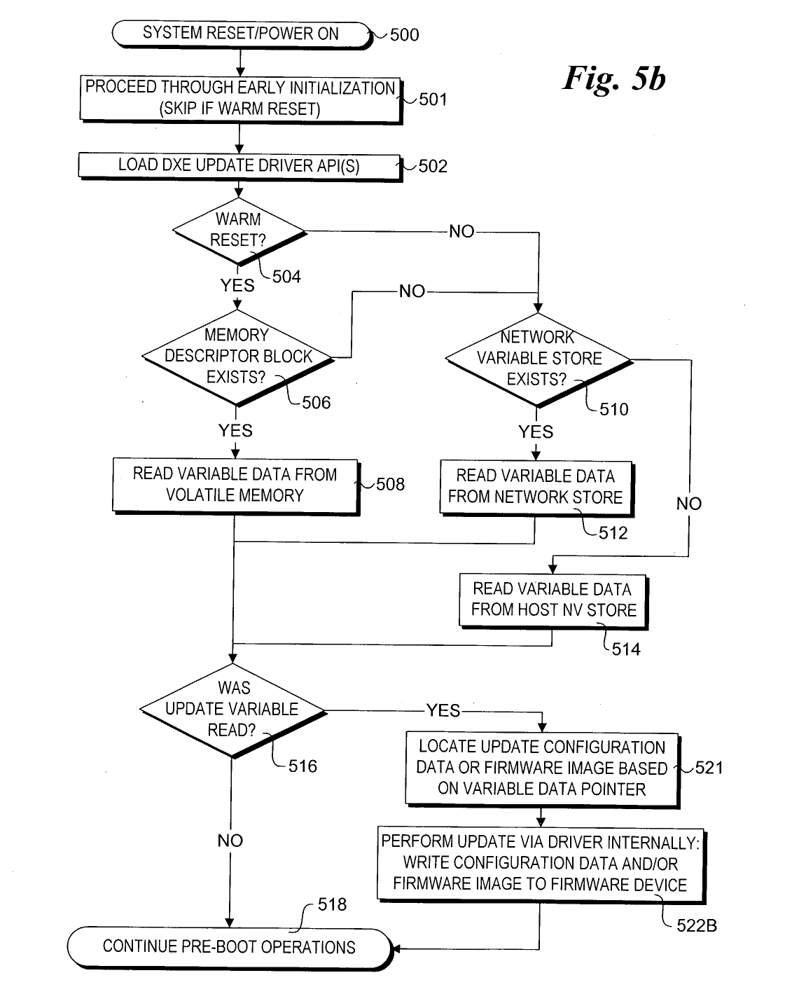

In accordance with one embodiment based on continuation of the first phase of the update process illustrated in FIG. 4, the second phase of the update process is performed in response to a subsequent cold boot or system reset (a.k.a. warm reset or warm boot) event, as depicted by a start block 500 in FIG. 5A. As is normal, in response to a cold boot, the boot block of the BFD is loaded and executed by processor 302 to perform early initialization operations in accordance with a block 501, while these operations are skipped for a warm reset. The DXE driver corresponding to the component for which firmware is updated is then loaded in a block 502.

Depending on the particular implementation, the following operations and logic may be provided solely by the DXE driver corresponding to the component for which the firmware is updated, or this task may be split between that DXE driver and another DXE driver that is used to provide generic update functionality.

First, the component-specific DXE driver or generic DXE drivers makes a determination in a decision block 504 to whether the system was restarted due to a warm reset. Under proper authorization, a system reset may be effectuated by a runtime application via the operating system. Thus, in response to a successful return to the update application, the application would request a system reset through the OS. If a warm reset is detected, the logic proceeds to a decision block 506 in which a determination is made to whether a memory descriptor block exists corresponding to the update. One difference between a warm reset and a cold boot is that data stored in the system's volatile memory (i.e., system RAM) is maintained for a warm reset. As a result, if the variable data was stored in the system's volatile memory in block 406 above, it will still be available for access, and a corresponding memory descriptor block would exist.

Existence of a memory descriptor block may be determined by the existence of a corresponding entry in the System Configuration Table. The memory descriptor contains information identifying a location of the variable data in the system's volatile memory. If the memory descriptor exists, the variable data is read from the volatile memory in a block 510.

Returning to decision blocks 504 and 506, if the system startup comprises a cold boot or a memory descriptor block does not exist, the variable data were not stored in volatile memory during the first phase. Accordingly, the logic proceeds to determine which non-volatile storage device the variable data are stored in. In a decision block 510, a determination is made to whether a network variable store exists. If the answer is YES, the location of the variable data and network store are identified, and the variable data are read from the network store in a block 512. If a network variable store doesn't exist, the variable data were stored on an NV store provided by the host (i.e., the computer system itself). Accordingly, the variable data are read from the host NV store in a block 514.

After retrieving the variable data from any of the foregoing storage devices, a determination is made to whether any of the variable data includes an update variable in a decision block 516. The update variable indicates that a corresponding firmware update has been set up during the first phase by the update application and is requested to be completed. If there is no pending update, corresponding to a normal warm or cold boot, the pre-boot operations are continued, as depicted by a completion block 518. If an update is pending, the logic proceeds to a block 520 in which the DXE driver API referenced by the update variable (the appropriate update API) is called. Based on additional information contained in the variable data, the update is then performed via the update API in a block 522A. In instances in which the update merely comprises updated configuration data that may be stored in the variable data, the update is effectuated by reading the updated configuration data and writing it to the firmware device corresponding to the update API. In instances in which the update requires a larger update image, the update image is read from the memory buffer identified by the Data parameter returned from a GetVariable call and written to an appropriate portion (memory address space) of the firmware device. In general, the location of the appropriate portion may be coded into the API itself, or may be obtained via the variable data.

It is noted that the ordering of the decision blocks and corresponding logic in the flowcharts of FIGS. 4 and 5 are merely exemplary, and not limiting. For instance, in accordance with the logic illustrated in the embodiments of FIGS. 4 and 5, there is a preference for storing variable data in volatile memory first, network variable storage second, and host variable storage third. This is merely one ordering scheme. One may design the logic to consider network storage or host variable storage prior to considering volatile memory, and any ordering combining the various of the variable data storage options may be implemented.

In accordance with another embodiment depicted in FIG. 5B, similar logic and operations are implemented up to and including decision block 516. However, in this instance the update is effectuated internally by a DXE update driver that does not publish an API. First, in a block 521, the update driver determines where the configuration parameters or update image is stored. Then, in a block 522B, the firmware update is handled internally by the update driver by writing the configuration data and/or firmware image to the firmware device corresponding to the system component for which firmware is updated.

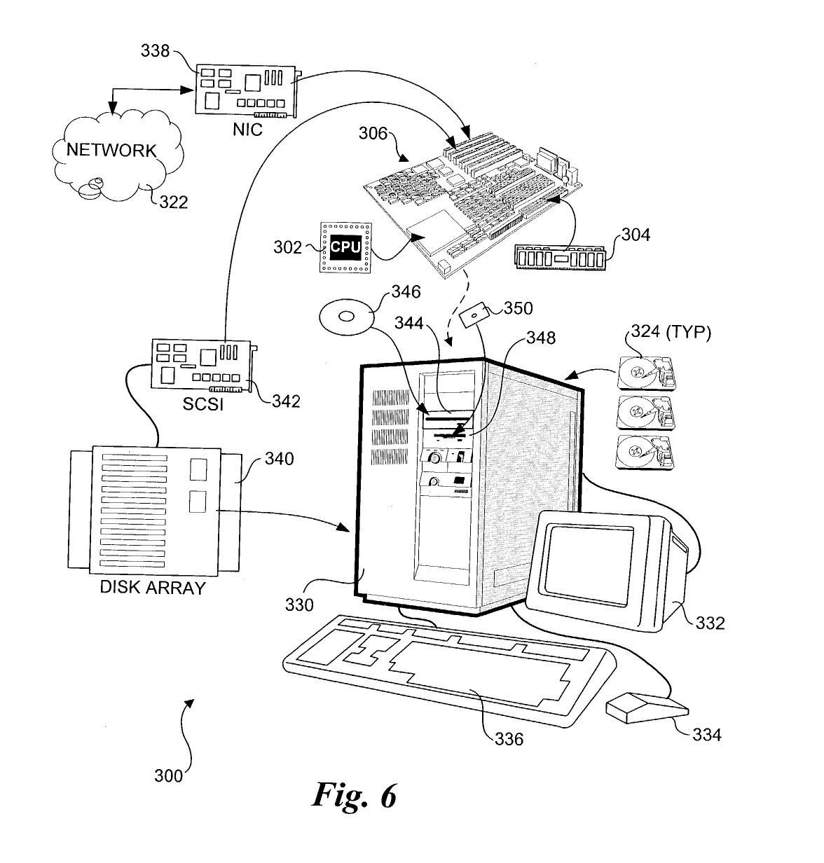

Further details of computer server 300 are shown in FIG. 6. In general, Computer server 300 may be used for running the firmware and software modules and components corresponding to EFI framework and update applications discussed above. The separate computer server of similar architecture may be used to host Network store 321, or the network store may comprise a network attached storage (NAS) appliance. Examples of computer systems that may be suitable for these purposes include stand-alone and enterprise-class servers operating UNIX-based and LINUX-based operating systems, as well as servers running the Windows NT, 2000 or 2003 Server operating systems. Furthermore, embodiments of the invention may be implemented on non-server computers, such as personal computers and the like.

Computer server 300 includes a chassis 330 in which motherboard 306 is mounted. In addition to one or more processors 302 and memory (e.g., DIMMs or SIMMs) 304, motherboard 306 populated with appropriate integrated circuits and interconnection buses, as is generally well known to those of ordinary skill in the art. A monitor 332 is included for displaying graphics and text generated by software programs and program modules that are run by the computer server. A mouse 334 (or other pointing device) may be connected to a serial port (or to a bus port or USB port) on the rear of chassis 330, and signals from mouse 334 are conveyed to the motherboard to control a cursor on the display and to select text, menu options, and graphic components displayed on monitor 332 by software programs and modules executing on the computer, such as update Applications X, Y, and Z. In addition, a keyboard 336 is coupled to the motherboard for user entry of text and commands that affect the running of software programs executing on the computer. Computer server 300 also includes a network interface card (NIC) 338 or equivalent circuitry built into the motherboard to enable the server to send and receive data via network 322.

Local non-volatile storage may be implemented via one or more hard disks 324 that are stored internally within chassis 330, and/or via a plurality of hard disks that are stored in an external disk array 340 that may be accessed via a SCSI card 342 or equivalent SCSI circuitry built into the motherboard. Optionally, disk array 340 may be accessed using a Fibre Channel link using an appropriate Fibre Channel interface card (not shown) or built-in circuitry, or other interfaces employed for accessing disk-based storage.

Computer server 300 generally may include a compact disk-read only memory (CD-ROM) drive 344 into which a CD-ROM disk 346 may be inserted so that executable files and data on the disk can be read for transfer into memory 304 and/or into storage on one or more of hard disks 324. Similarly, a floppy drive 348 and corresponding floppy disk 350 may be provided for such purposes. Other mass memory storage devices such as an optical recorded medium or DVD drive may also be included. The machine instructions comprising the software components that cause processor(s) 302 to implement the operations of the update application embodiments discussed above will typically be distributed on floppy disks 350 or CD-ROMs 346 (or other memory media) and stored on one or more hard disks 324 until loaded into memory 304 for execution by processor(s) 302. Optionally, the machine instructions may be loaded via network 338 as a carrier wave file. The firmware instructions that may be executed by processor 302 to perform the various firmware operations discussed above will generally be stored on corresponding non-volatile rewritable memory devices, such as flash devices, EEPROMs, and the like. The firmware embodied as a carrier wave may also be downloaded over a network and copied to a firmware device (e.g., “flashed” to a flash device), or may be originally stored on a disk media and copied to the firmware device.

Thus, embodiments of this invention may be used as or to support firmware and software instructions executed upon some form of processing core (such as the CPU of a computer) or otherwise implemented or realized upon or within a machine-readable medium. A machine-readable medium includes any mechanism for storing or transmitting information in a form readable by a machine (e.g., a computer). For example, a machine-readable medium can include such storage means such as a read only memory (ROM); a magnetic disk storage media; an optical storage media; and a flash memory device, etc. In addition, a machine-readable medium can include propagated signals such as electrical, optical, acoustical or other form of propagated signals (e.g., carrier waves, infrared signals, digital signals, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method, comprising:
providing at least one programmatic interface to facilitate update of firmware corresponding to a computer system component, said at least one programmatic interface being independent of operating systems that may be run on the computer system; and
employing said at least one programmatic interface in connection with performing an update of the firmware for the computer system component.

2. The method of claim 1, wherein the method updates firmware stored in a boot firmware device of the computer system.

3. The method of claim 1, wherein the computer system component comprises an add-in card.

4. The method of claim 1, wherein said at least one programmatic interface is published during a pre-boot phase during which the computer system is initialized prior to booting the operating system.

5. The method of claim 1, wherein the firmware update is performed via a two-phase process including a first phase that is performed during an operating system runtime phase and a second phase that is performed during a computer system pre-boot phase.

6. The method of claim 5, wherein the second phase is commenced by automatically causing a warm reset for the computer system after the first phase is completed.

7. The method of claim 5, wherein the firmware is updated via said at least one programmatic interface by performing operations comprising:
storing update data corresponding to the firmware update via an update application running during the operating system runtime phase;
retrieving the update data during the pre-boot phase; and
employing a firmware component identified by the update data to effectuate the firmware update.

8. The method of claim 7, wherein the update data include firmware configuration data corresponding to the firmware update.

9. The method of claim 7, wherein the update data includes information identifying a location of a firmware image that is copied to a firmware device on which firmware corresponding to the system component is stored to effectuate the firmware update.

10. The method of claim 7, wherein the computer system includes volatile memory, and the update data are stored in the volatile memory.

11. The method of claim 7, wherein the update data are stored on a computer network to which the computer system is coupled.

12. The method of claim 7, wherein the update data are stored in a non-volatile storage device of the computer system.

13. The method of claim 7, wherein the firmware component provides an interface for directly accessing a firmware device on which the firmware to be updated is stored.

14. The method of claim 7, wherein the method is performed in accordance with the extensible firmware interface (EFI) framework, and said at least programmatic interface includes a variable services programmatic interface corresponding to runtime services provided by the EFI framework that is used to interface with the update application.

15. The method of claim 14, wherein said at least one programmatic interface further includes a programmatic interface published by an EFI firmware driver.

16. The method of claim 15, wherein the programmatic interface published by the EFI firmware driver is specific to the computer system component for which firmware is updated and provides direct access to a firmware device on which the firmware for the computer system component is stored.

17. An article of manufacture, comprising:
a machine-readable medium on which instructions are stored, which when executed facilitate an update of firmware for a computer system component by performing operations including:
publishing an operating system-independent firmware application program interface (API) that is accessible during operating system runtime operations;
receiving update data via the firmware API during operating system runtime; and
employing the update data to update the firmware for the computer system component.

18. The article of manufacture of claim 17, wherein the update of the firmware is effectuated by performing operations comprising:
retrieving the update data during a pre-boot computer system initialization phase; and
employing a firmware component identified by the update data to facilitate the firmware update.

19. The article of manufacture of claim 18, wherein the firmware component publishes a second firmware API that is used to interface with a firmware device on which the firmware corresponding to the update are stored.

20. The article of manufacture of claim 18, wherein the update data include firmware configuration data corresponding to the firmware update, and wherein execution of the instructions further performs the operation of writing data corresponding to the firmware configuration data to a firmware device used to store the firmware being updated.

21. The article of manufacture of claim 18, wherein the update data includes information identifying a memory buffer in which a firmware image corresponding to the firmware update is stored, and wherein execution of the instructions further performs the operation of writing data corresponding to the firmware image to a firmware device used to store the firmware being updated.

22. The article of manufacture of claim 18, wherein the computer system includes volatile memory, and the update data are stored in the volatile memory.

23. The article of manufacture of claim 18, wherein the update data are stored on a computer network to which the computer system is coupled.

24. The article of manufacture of claim 18, wherein the update data are stored in a portion of a firmware device comprising non-volatile random access memory (NVRAM).

25. The article of manufacture of claim 18, wherein the update data are stored on a host-protected area (HPA) of a hard disk device operatively coupled to a motherboard for the computer system

26. The article of manufacture of claim 18, wherein the instructions correspond to firmware components that comply to the extensible firmware interface (EFI) framework standard, and the firmware API corresponds to a variable services EFI runtime service component.

27. The article of manufacture of claim 18, wherein the firmware component comprises an EFI driver that is specific to the computer system component for which firmware is updated and provides direct access to a firmware device on which the firmware for the computer system component is stored.

28. A computer system, comprising:
a motherboard;
a processor, coupled to the motherboard;
volatile memory, coupled to the motherboard; and
a boot firmware device, coupled to the motherboard and comprising flash memory having firmware instructions stored therein, which when executed by the processor effectuate an update of firmware for a computer system component by performing operations including:
publishing generic and component-specific firmware application program interfaces (APIs), each being independent of operating systems that may be run on the computer system;
enabling an operating system runtime application to define update data via the generic interface; and
updating the firmware for the system component via the component-specific firmware API based on the update data.

29. The computer system of claim 28, further comprising an add-in card coupled to the motherboard, the add-in card including a non-volatile rewritable memory device having firmware stored thereon that is updated during the firmware update.

30. The computer system of claim 28, wherein the update data includes information identifying a memory buffer stored in the volatile memory in which a firmware image corresponding to the firmware update is stored, and wherein the component-specific firmware API facilitates the operation of writing data corresponding to the firmware image to a firmware device used to store the firmware being updated.
